(19) United States
(12) Patent Application Publication
(10) Pub. No.: US 2026/0135653 A1
(43) Pub. Date: May 14, 2026

(54) TECHNIQUES FOR BROADCAST CHANNEL DESIGN FOR LOW POWER WIDE AREA COMMUNICATIONS

(71) Applicant: Lenovo (United States) Inc., Morrisville, NC (US)

(72) Inventors: Hossein Bagheri, Dearborn Heights, MI (US); Vijay Nangia, Woodridge, IL (US); Karthikeyan Ganesan, Kronberg im Taunus (DE)

(21) Appl. No.: 18/942,090

(22) Filed: Nov. 8, 2024

(51) Int. Cl. H04L 5/00; H04L 1/00

(52) U.S. Cl. CPC H04L 5/005; H04L 1/0071

(57) ABSTRACT

Various aspects of the present disclosure relate to techniques for control channel design. A user equipment (UE) may be configured to receive a message comprising a pattern of synchronization signal blocks (SSBs) spanning a time duration, determine, based on the pattern of SSBs, a first subset of SSB indices associated with a first time period of the time duration and a second subset of SSB indices associated with a second time period of the time duration, and receive an SSB in accordance with an associated SSB index based on the pattern of SSBs, the first and second subsets of SSB indices, and the time period corresponding to the SSB.

### TECHNICAL FIELD

The present disclosure relates to wireless communications, and more specifically to techniques (e.g., methods, designs) for broadcast channel design for low power wide area (LPWA) communications.

### BACKGROUND

A wireless communications system may include one or multiple network communication devices, such as base stations, which may support wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

A UE for wireless communication is described. The UE may be configured to, capable of, or operable to receive a message comprising a pattern of synchronization signal blocks (SSBs) spanning a time duration; determine, based on the pattern of SSBs, a first subset of SSB indices associated with a first time period of the time duration and a second subset of SSB indices associated with a second time period of the time duration; and receive an SSB in accordance with an associated SSB index based on the pattern of SSBs, the first and second subsets of SSB indices, and the time period corresponding to the SSB.

A method for wireless communication performed by a UE. The method may include receiving a message comprising a pattern of SSBs spanning a time duration; determining, based on the pattern of SSBs, a first subset of SSB indices associated with a first time period of the time duration and a second subset of SSB indices associated with a second time period of the time duration; and receive an SSB in accordance with an associated SSB index based on the pattern of SSBs, the first and second subsets of SSB indices, and the time period corresponding to the SSB.

A processor for wireless communication is described. The processor may be configured to, capable of, or operable to receive a message comprising a pattern of SSBs spanning a time duration; determine, based on the pattern of SSBs, a first subset of SSB indices associated with a first time period of the time duration and a second subset of SSB indices associated with a second time period of the time duration; and receive an SSB in accordance with an associated SSB index based on the pattern of SSBs, the first and second subsets of SSB indices, and the time period corresponding to the SSB.

A network equipment (NE) for wireless communication is described. The NE may be configured to, capable of, or operable to determine a pattern for occurrence of SSBs, wherein the SSBs occur in at least two SSB bursts and each of the two SSB bursts include SSBs with at least one common SSB index and one different SSB index in the at least two SSB bursts, and the at least two SSB bursts are non-overlapping in time; and transmit a signal indicating the pattern for occurrence of SSBs.

Another method for wireless communication performed by a NE. The method may include determining a pattern for occurrence of SSBs, wherein the SSBs occur in at least two SSB bursts and each of the two SSB bursts include SSBs with at least one common SSB index and one different SSB index in the at least two SSB bursts, and the at least two SSB bursts are non-overlapping in time; and transmitting a signal indicating the pattern for occurrence of SSBs.

Another processor for wireless communication is described. The processor may be configured to, capable of, or operable to determine a pattern for occurrence of SSBs, wherein the SSBs occur in at least two SSB bursts and each of the two SSB bursts include SSBs with at least one common SSB index and one different SSB index in the at least two SSB bursts, and the at least two SSB bursts are non-overlapping in time; and transmit a signal indicating the pattern for occurrence of SSBs.

### BRIEF DESCRIPTION OF THE DRAWINGS

FIG. 1 illustrates an example of a wireless communications system in accordance with aspects of the present disclosure.

FIG. 2 illustrates an example of an SSB structure in accordance with aspects of the present disclosure.

FIG. 3 illustrates an example of a bandwidth part (BWP) operation in accordance with aspects of the present disclosure.

FIG. 4 illustrates an example of SSB structure in accordance with aspects of the present disclosure.

FIG. 5 illustrates an example of an SSB burst in accordance with aspects of the present disclosure.

FIG. 6 illustrates an example of an SSB burst in accordance with aspects of the present disclosure.

FIG. 7 illustrates an example of an SSB burst in accordance with aspects of the present disclosure.

FIG. 8 illustrates an example of an SSB burst in accordance with aspects of the present disclosure.

FIG. 9 illustrates an example of an SSB burst in accordance with aspects of the present disclosure.

FIG. 9-1 illustrates an example of an SSB burst in accordance with aspects of the present disclosure.

FIG. 10 illustrates an example of combining sequences in accordance with aspects of the present disclosure.

FIG. 11 illustrates an example SSB structure in accordance with aspects of the present disclosure.

FIG. 12 illustrates an example of a user equipment (UE) in accordance with aspects of the present disclosure.

FIG. 13 illustrates an example of a processor in accordance with aspects of the present disclosure.

FIG. 14 illustrates an example of a network equipment in accordance with aspects of the present disclosure.

FIG. 15 illustrates a flowchart of method in accordance with aspects of the present disclosure.

FIG. 16 illustrates a flowchart of method in accordance with aspects of the present disclosure.

FIG. 17 illustrates a flowchart of method in accordance with aspects of the present disclosure.

FIG. 18 illustrates a flowchart of method in accordance with aspects of the present disclosure.

### DETAILED DESCRIPTION

A wireless communication system may support LPWA communications. LPWA communications may include Internet of Things (IoT) communications by enabling low-power devices, such as IoT devices, Narrowband IoT (NB-IoT) devices, and Ambient-IoT (A-IoT devices), to perform operations (e.g., transmitting, receiving, processing, among other operations) with minimal power consumption. The power consumption for operations, such as digital baseband processing, may scale with bandwidth. Some devices may be operable or configured to operate with limited bandwidth to maintain low power consumption. Therefore, it may be desired to establish a unified framework and signaling protocol for devices supporting and deployed in wireless communication systems that support radio access technologies (e.g., technologies beyond 5G, such as 5G-Advanced, 6G). For example, broadcast signaling may provide information, such as control channel monitoring information, before occurrence of a random access procedure (e.g., similar to a Master Information Block (MIB) in 5G New Radio (NR)). This information can be utilized by both LPWA UE (LPWA-UE) and non-LPWA UE (non-LPWA UE).

Various aspects of the present disclosure provide details of physical broadcast channel (PBCH) design utilizing a limited bandwidth and supporting both types of UEs with a common signal. One issue to address in this scenario is that a duration of blocks (e.g., SSBs) including broadcast signals may become larger to provide good coverage, leading to a situation where not all the broadcast signals associated with different attributes (e.g., beams) can be included within a period of the periodic broadcast blocks (SSB burst periodicity). To provide blocks with different attributes, aspects depicted herein provide for techniques to shorten a duration of one or more the broadcast signals (corresponding to one or more SSB indices), and/or to provide different broadcast signals in different time periods (subset of SSB indices in an SSB burst) such that a time period (including multiple consecutive SSB bursts/MIB periodicities) includes all the blocks. Hence, the design includes mechanisms for UEs in idle and/or connected modes to determine a location of broadcast signals associated with different attributes, such as beams, within a time window (such as multiple of MIB periodicity), a number of PBCH symbols and their spacings, and a reference signal distribution within the broadcast transmission.

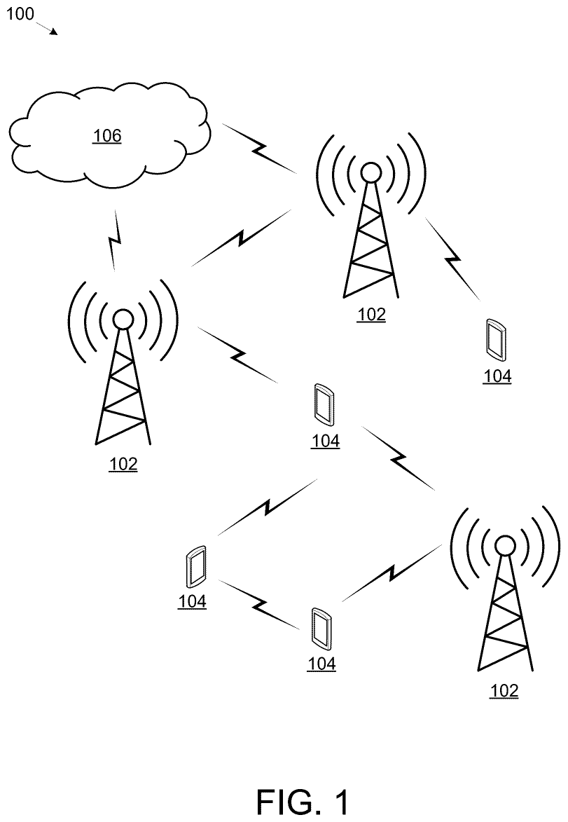

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one embodiment, the system 100 shown in FIG. 1 is configured to, capable or, or operable to implement the solutions described herein, namely receive a message comprising a pattern of SSBs spanning a time duration, wherein the SSBs comprise one or more synchronization signals and one or more broadcast messages, determine, based on the pattern of SSBs, a first subset of SSB indices associated with a first time period of the time duration and a second subset of SSB indices associated with a second time period of the time duration, wherein the first and second subsets of SSB indices have at least one index that is common and at least one index that is different, and wherein the first and second time periods do not overlap, and receive an SSB in accordance with an associated SSB index based on the pattern of SSBs, the first and second subsets of SSB indices, and the time period corresponding to the SSB.

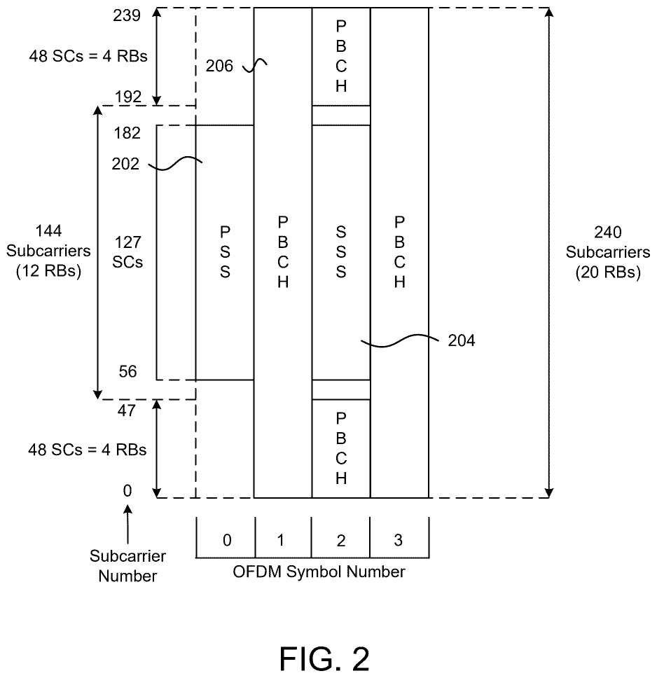

FIG. 2 illustrates an example of an SSB structure in accordance with aspects of the present disclosure. An SSB includes a primary synchronization signal (PSS) 202, secondary synchronization signal (SSS) 204, and physical broadcast channel (PBCH) 206. The SSB bandwidth is 20 RBs. After acquiring synchronization (and Cell-ID) and MIB (PBCH), the UE searches CORESET 0 (determined from the MIB) to obtain SIB1 information. The minimum number of RBs for CORESET 0 in 5G NR is 24 RBs.

The SSB shown in FIG. 2 may be an example of a pattern for an SSB block that contains synchronization signals and broadcast signals. As described herein, the pattern of the SSB may be used to determine indices for the SSB to facilitate broadcast channel design for low power wide area IoT communications.

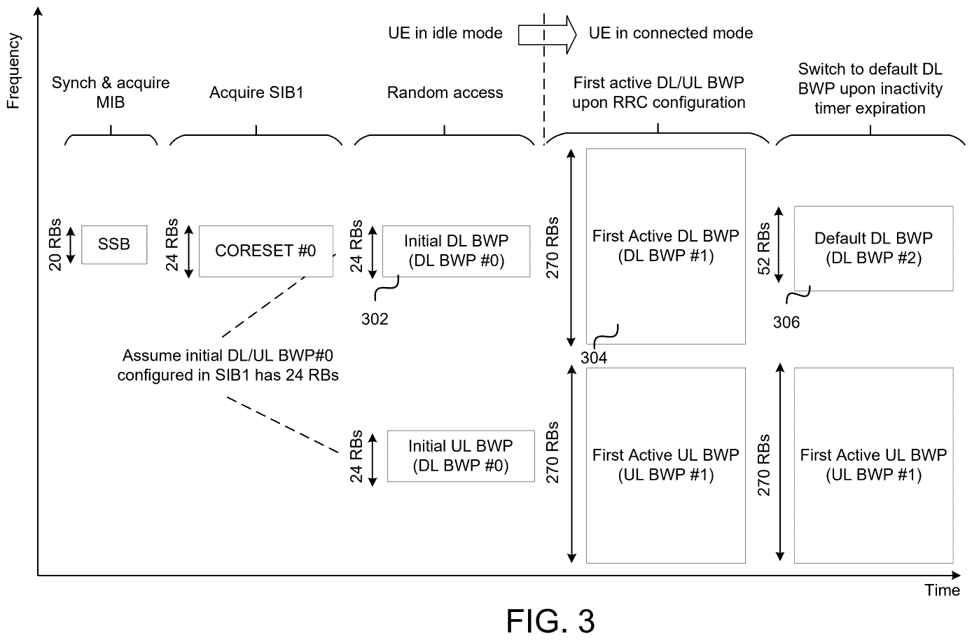

FIG. 3 illustrates an example of a BWP operation in accordance with aspects of the present disclosure. As it relates to the subject matter herein, FIG. 3 may be an example of the operation of a UE going from idle to connected mode. After acquiring an SSB (and Cell-ID) and MIB (PBCH), and SIB1, the UE can perform a random access procedure, and then transition from an idle mode to a connected mode. The UE may use different BWPs throughout the BWP operation, starting from communicating on an initial BWP 302 during random access to communicating on an active BWP 304 (which can be chosen from a set of configured BWPs), and a default BWP 306 when a timer expires.

In one embodiment, the UE may include a coding unit used to encode or decode transmission and reception respectively. In some instances, PBCH data arrives to the coding unit in the form of a maximum of one transport block every 80 ms, e.g., according to TS 38.212 (incorporated herein by reference). In 5G NR, PBCH payload may be at most 32 bits and may be appended by 24 bits cyclic redundancy check (CRC). A polar encoded stream may have 512 bits, and after rate matching, it ends up having 864 bits. If Quadrature Phase Shift Keying (QPSK) is used, then 432 Resource Element (REs) may be needed. Demodulation reference signal (DMRS) occupies 144 additional REs, leading to 144*4 REs for PBCH.

In one embodiment, an SSB burst including multiple SSBs, each associated with different realization of a transmission attribute, such as different transmission beams, can help the UE choose a realization of the transmission attribute. In 5G NR, to increase the coverage of SSBs, the gNB performs beamforming for each SSB. The SSB burst is included within a 5 ms (half frame) time window. The distance (e.g., time difference) between two consecutive SSBs is such that there is sufficient time for the UE to receive different beams. In some examples, a time slot may include two SSBs. For 15 KHz subcarrier spacing (SCS), the first SSB starts at symbol 2 and the second SSB starts at symbol 8, and this repeats two times for fc<=3 GHz (third SSB, and fourth SSBs start at symbol 2 and 8 of the next slot, respectively), and four times for 3 GHz<fc<6 GHz (third, fourth, fifth, sixth, seventh, eighth SSBs start at symbols 2, 8 of the three next slots, respectively).

In the following disclosure, it is assumed that both the LPWA and non-LPWA UEs acquire the same synchronization signals (e.g., PSS and SSS) and that both LPWA and non-LPWA UEs decode the same PBCH. As LPWA UEs operate on small BW, the SSB structure needs to be spread more in time compared to that of the SSB structure in 5G.

In one embodiment, aspects described herein provide for various embodiments regarding how PSS, SSS, and PBCH symbols are assembled in an SSB block. It is assumed that each symbol can be occupied by one of PSS, SSS, and PBCH unless otherwise stated. For representation, PSS, SSS, and PBCH are referred to as P, S, and B, respectively. For instance, an SSB with 7 symbols defined by {P, P, B, S, S, B, B} shows an SSB having two PSS symbols in the beginning, followed by one PBCH symbol, and two subsequent SSS symbols, and 2 PBCH symbols at the end. In another example, an SSB with six symbols defined by {P, B, B, S, B, B} has one PSS symbol, followed by 2 PBCH symbols, followed by an SSS symbol, followed by 2 PBCH symbols, and {P, B, B, B, S, B} defines an SSB having one PSS symbol, followed by 3 PBCH symbols, followed by an SSS symbol, followed by another PBCH symbol.

For the following, it is assumed that PSS and SSS that is used in 5G is also used for 6G (although this assumption is not restricting and made for simplicity). Further, in one embodiment, an LPWA UE can operate in 12 RB BW at least for SSB detection and with the same PBCH coverage (same number of REs for PBCH and its associated DMRS) as 5G.

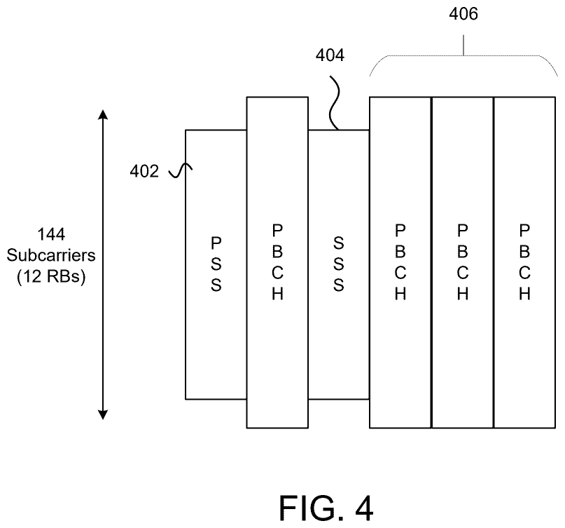

FIG. 4 illustrates an example of an SSB structure in accordance with aspects of the present disclosure. Based on the foregoing assumptions, FIG. 4 illustrates an SSB structure in 6G. For the case of high doppler (e.g., when the mobility speed is high), a robust design is to have PSS 402 and SSS 404 close to each other in time domain, so that roughly the same channel may be experienced by both PSS 402 and SSS 404. Additionally, a UE may detect SSS 404 is detected based on the detected PSS 402, which is why the three PBCH symbols 406 are located at the end of the SSB.

The SSB shown in FIG. 4 may be an example of a pattern for an SSB block that contains synchronization signals and broadcast signals. As described herein, the pattern of the SSB may be used to determine indices for the SSB to facilitate broadcast channel design for low power wide area IoT communications.

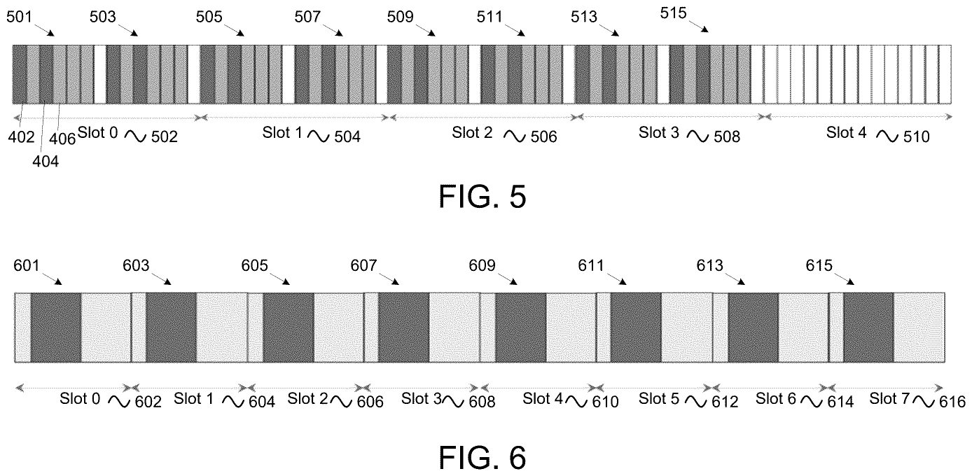

FIG. 5 illustrates an example of an SSB burst in accordance with aspects of the present disclosure. In one embodiment, the SSB burst shown in FIG. 5 is a six symbol SSB structure that contains 8 SSBs 501-515 in a half frame for 15 KHz SCS (comprising slots 0-slot 4 502-510). The SSB burst pattern shown in FIG. 5 may facilitate limited bandwidth PBCH design to support both types of UEs (LPWA-UEs and non-LPWA UEs) with the same signal by extending the SSB in time (extending the SSB across additional symbols based on the SSB structure shown in FIG. 4).

FIG. 6 illustrates an example of an SSB burst in accordance with aspects of the present disclosure. In one embodiment, the SSB burst shown in FIG. 6 is an alternative arrangement of the SSBs 601-615 within the SSB burst, where the SSBs are spread across multiple slots in a slot 602-616. The SSB pattern shown in FIG. 6 may facilitate limited bandwidth PBCH design to support both types of UEs (LPWA-UEs and non-LPWA UEs) with the same signal by extending the SSB in time (extending the SSB across additional symbols based on the SSB structure shown in FIG. 4).

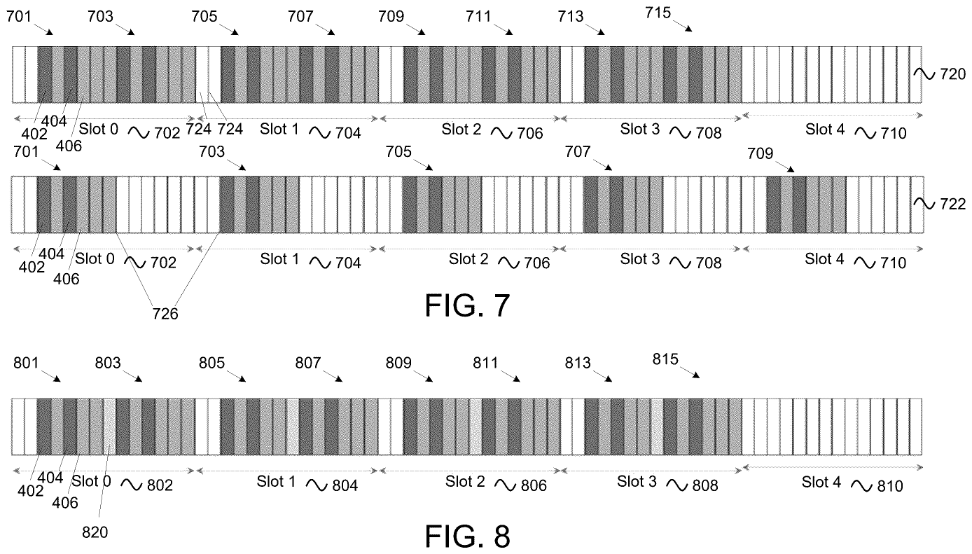

FIG. 7 illustrates an example of an SSB burst in accordance with aspects of the present disclosure. In one embodiment, FIG. 7 shows two possibilities for an SSB burst structure if the SSB 701-715 is not mapped to the first two symbols of a slot 701-710. In 5G, SSB 701-715 is not mapped to the first two symbols 724 of a slot 702-710 (e.g., for avoiding collision with control channel or for coexistence with LTE). In the first option 720, the first two symbols 724 are skipped, and then SSBs, e.g., SSB 701 and SSB 703, and placed consecutively in the same slot 702. In an embodiment, a gap (e.g., two symbols 724) between two consecutive SSBs can be added in a slot 702-710. In a second option 722, SSBs 701-709 are each placed in different slots 702-710, leaving a larger gap 726 between SSBs. The SSB pattern shown in FIG. 7 may facilitate limited bandwidth PBCH design to support both types of UEs (LPWA-UEs and non-LPWA UEs) with the same signal by extending the SSB in time (extending the SSB across additional symbols based on the SSB structure shown in FIG. 4).

FIG. 8 illustrates an example of an SSB burst in accordance with aspects of the present disclosure. In FIG. 8, the SSB burst structure shows a PBCH symbol 820 of an SSB 801-815 that is dropped in every other SSB 801-815, e.g., dropping the last PBCH 820 symbol of the first SSB in each slot 802-810. The SSB pattern shown in FIG. 8 may facilitate limited bandwidth PBCH design to support both types of UEs (LPWA-UEs and non-LPWA UEs) with the same signal by extending the SSB in time (extending the SSB across additional symbols based on the SSB structure shown in FIG. 4).

In one embodiment, a UE in RRC-idle or RRC-inactive modes may perform blind detection between two hypothesis to determine if the detected PSS/SSS is associated with a SSB that has 3 or 2 symbols of PBCH at the end of the SSB. In certain embodiment, a UE in RRC-idle or RRC-inactive modes detects DMRS assuming only 2 symbols for PBCH after the SSS symbol(s). Based on the detected DMRS (e.g., based on the detection of DMRS scrambling sequence ID), the UE determines how many PBCH symbols is associated with the detected PSS/SSS.

In one embodiment, to have a balanced (e.g., over time) SSB detection performance across the UEs in a cell, the subset of SSBs with reduced number of SSB symbols can be changed from one predefined period (e.g., 80 ms) to another.

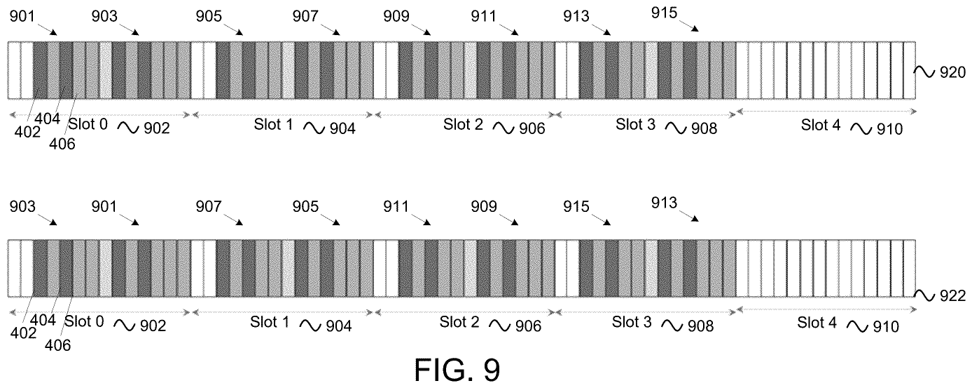

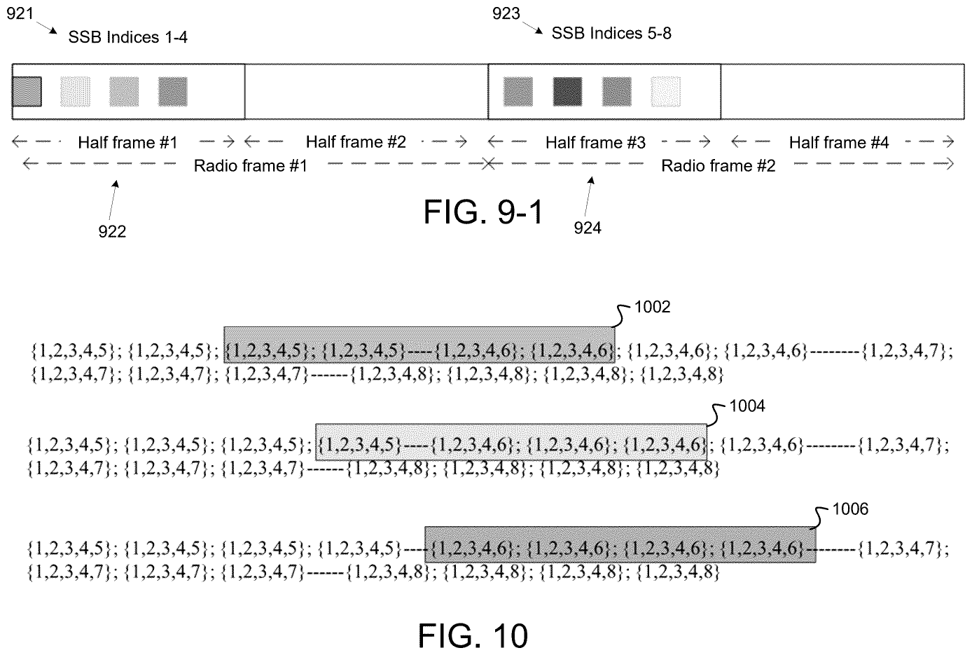

FIG. 9 illustrates an example of an SSB burst in accordance with aspects of the present disclosure. In FIG. 9, the top FIG. 920 shows SSBs 901-915 in a first predefined period, and the bottom FIG. 922 shows SSBs 901-915 in a second predefined period, where odd and even SSBs 901-915 in a slot 902-910 are swapped. In the depicted embodiment, one approach is to swap the location of odd and even SSBs 901-915 of a slot 902-910 every predefined period (e.g., 80 ms). An example of swapping every two consecutive predefined periods (e.g., 160 ms) is shown in FIG. 9. The SSB pattern shown in FIG. 9 may facilitate limited bandwidth PBCH design to support both types of UEs (LPWA-UEs and non-LPWA UEs) with the same signal by extending the SSB in time (extending the SSB across additional symbols based on the SSB structure shown in FIG. 4).

A more general approach could be to change (e.g., rotate/shift) the location of SSBs in each of the predefined periods from one predefined period to another. In that case, the slot index associated with each SSB may be indicated (e.g., instead of or in addition to the SSB index). In one embodiment, the slot index indication could be done by PBCH.

In one embodiment, a UE in RRC connected mode does not need to perform such extra blind detection as the pattern of SSBs with their corresponding number of PBCH symbols can be RRC configured. An example implementation of such indicated patten could be one RRC bit may indicate if the last PBCH symbol of the first SSB in each slot containing SSB is to be dropped. For example, In the latter case of FIG. 7, not all 8 SSB indices can fit in a half frame; only 5 out of 8 indices can fit.

There could be several solutions to include more SSB indices, e.g., to cover more beams. In one embodiment, the smallest SSB periodicity can be larger than 5 ms (e.g., 10 ms), when there are more than 5 SSBs to cover (e.g., with 15 KHz SCS or 1 ms slot duration).

FIG. 9-1 illustrates an example of an SSB burst in accordance with aspects of the present disclosure. In one embodiment, SSBs 921, 923 are split between two half-frames, e.g., half frame #1 922 and half frame #3 924. The SSB duration is a half frame e.g., 5 ms, but instead of skipping some SSBs, the remaining SSB indices are sent in the next occurrence of half frame. Thus, more than one half frame is needed to transmit all SSBs without skipping. The SSB pattern shown in FIG. 9-1 may facilitate limited bandwidth PBCH design to support both types of UEs (LPWA-UEs and non-LPWA UEs) with the same signal by extending the SSB in time (extending the SSB across additional symbols based on the SSB structure shown in FIG. 4).

In one embodiment, each SSB period or each multiple SSB periods/duration of time (e.g., every 80 ms) contains different sets of SSBs with a determined sequence of occurrence. For instance, with SSB periodicity of 20 ms, the SSB index sequence in these periods can be as follows (each {.} shows the SSB indices within a SSB period, and ‘----’ shows a duration of time/multiple SSB periods):
{1,2,3,4,5}; {1,2,3,4,5}; {1,2,3,4,5}; {1,2,3,4,5}----{1,2,3,4,6}; {1,2,3,4,6}; {1,2,3,4,6}; {1,2,3,4,6}--------{1,2,3,4,7}; {1,2,3,4,7}; {1,2,3,4,7}; {1,2,3,4,7}------{1,2,3,4,8}; {1,2,3,4,8}; {1,2,3,4,8}; {1,2,3,4,8}.

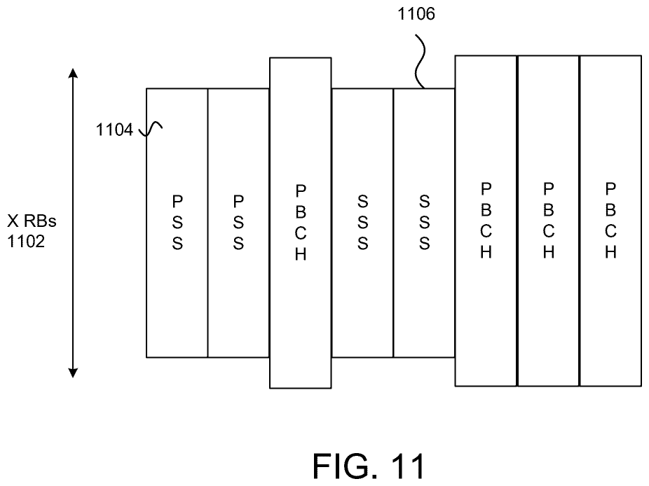

FIG. 10 illustrates an example of combining sequences in accordance with aspects of the present disclosure. In such an embodiment, the UE can (soft) combine PSS or SSS sequences occurring every 20 ms; however, there is a chance that PSS/SSS sequences associated with two different SSB indices get combined (e.g., [SSB5, SSB5, SSB6, SSB6] over 80 ms as represented by {1,2,3,4,5}----{1,2,3,4,6} in the above paragraph). Such soft combining may be performed if SSB indices (e.g., 5, and 6) have some commonalities, such as having their associated beams overlapped. The UE may need to perform multiple hypothesis testing where the UE, after soft combining multiple PSS/SSS, may perform PBCH decoding and perform CRC check. Upon failure of the CRC check, the UE may shift PSS/SSS combining by one period e.g., as shown in FIG. 9.

FIG. 10 illustrates sliding PSS/SSS combining where PSS/SSS combining is performed over [SSB5, SSB5, SSB6, SSB6] 1002 over 80 ms in the top figure. Upon PBCH CRC check failure, PSSS/SSS combining is performed over [SSB5, SSB6, SSB6, SSB6] 1004 over 80 ms in the middle figure. Upon PBCH CRC check failure, PSS/SSS combining is performed over [SSB6, SSB6, SSB6, SSB6] 1006 over 80 ms in the bottom figure. Upon successful CRC check, the UE stops shifting to the next SSB period for PSS/SSS combining across multiple periods.

In one embodiment, for connected mode UEs, RRC configuration may indicate the pattern of occurrence of SSBs within a time window (e.g., 80 ms). For instance, the indicated pattern could look like this: {1,2,3,4,5}; {1,2,3,4,6}; {1,2,3,4,7}; {1,2,3,4,8}.

FIG. 11 illustrates an example SSB structure in accordance with aspects of the present disclosure. It is assumed that PSS 1104 and SSS 1106 BW are small, e.g., ‘X’ RBs 1102, e.g., X=6 and PBCH at least for LPWA UE is sent in ‘X’ RBs 1102. Due to the small BW of PSS 1104 and SSS 1106, the PSS 1104 and the SSS 1106 are transmitted in more than 1 symbol each. For such a case, not all 8 SSB indices can fit in a half frame if at least 1 symbol gap is needed between two SSB indices, and if each SSB is contained in a slot, only 5 out of 8 indices can fit. Similar solutions to those shown in the bottom FIG. 722 of FIG. 7 can be applicable to this case.

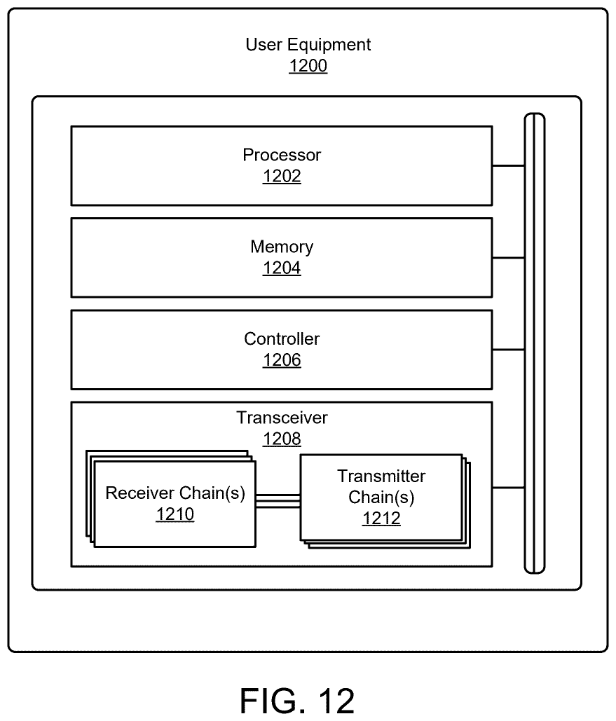

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may receive a message comprising a pattern of SSBs spanning a time duration, wherein the SSBs comprise one or more synchronization signals and one or more broadcast messages, determine, based on the pattern of SSBs, a first subset of SSB indices associated with a first time period of the time duration and a second subset of SSB indices associated with a second time period of the time duration, wherein the first and second subsets of SSB indices have at least one index that is common and at least one index that is different, and wherein the first and second time periods do not overlap, and receive an SSB in accordance with an associated SSB index based on the pattern of SSBs, the first and second subsets of SSB indices, and the time period corresponding to the SSB.

In one embodiment, the first time period comprises a first set of slots and the second time period comprises a second set of slots, and wherein, for at least one SSB index, a slot index within the first time period is different than a corresponding slot index with the second time period. In one embodiment, the first and second time periods comprise the same number of slots.

In one embodiment, the first time period comprises a first set of slots and the second time period comprises a second set of slots, and wherein, a first SSB index is associated with a first slot index within the first time period and a second SSB index is associated with a second slot index within the second time period, and wherein the first slot index is different than the second slot index. In one embodiment, the first and second time periods comprise the same number of slots.

In one embodiment, the time duration is a multiple of a duration in which a MIB remains the same. In one embodiment, the first and second time periods are associated with a SSB burst duration or a MIB duration.

In one embodiment, the first and second time periods each have a duration of a half frame. In one embodiment, the pattern of SSBs in the time duration comprises SSB indices associated with the first time period and the second time period.

In one embodiment, the message comprises an interleaving parameter for SSB indices. In one embodiment, the processor 1200 is configured to cause the UE to further determine the SSB indices associated with the first and second time periods based on the interleaving parameter.

In one embodiment, the first time period, the second time period, or a combination thereof comprises up to a predetermined number of SSB indices. In one embodiment, the first time period corresponds to an odd frame and the second time period corresponds to an even frame.

In one embodiment, the processor 1200 is configured to detect a synchronization signal, determine, based on the detected synchronization signal presence of an SSB wherein the SSB is at least comprised of a set of PBCH symbols, detect DMRS of a first number of PBCH symbols of the SSB, determine based on the detected DMRS, a second number of PBCH symbols, and decode PBCH of the SSB based on the second number of PBCH symbols.

In one embodiment, the second number of PBCH symbols is not smaller than the first number of PBCH symbols. In one embodiment, the at least one of the additional PBCH symbols of the second number of PBCH symbols does not include any DMRS REs or has smaller number of DMRS REs compared to the PBCH symbols of the first number of PBCH symbols.

In one embodiment, the additional PBCH symbols of the second number of PBCH symbols occur after the first number of PBCH symbols in the SSB. In one embodiment, the processor 1200 is configured to receive a higher layer message indicating whether the location of SSBs of the same index change from one time period to another time period according to a predetermined pattern. In one embodiment, the location of SSBs of the same index can be either in a first portion of a slot or a second portion of the slot.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1002.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receiving the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the received signal and obtain the transmitted data by reversing the modulation technique applied during transmission of the signal. The receiver chain 1210 may include at least one decoder for decoding and processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

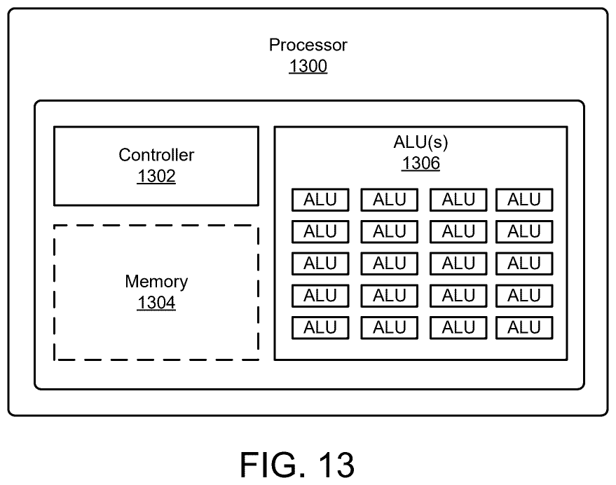

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory address of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, arithmetic logic units (ALUs), and other functional units of the processor 1300.

The memory 1304 may include one or more caches (e.g., memory local to or included in the processor 1300 or other memory, such RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, the controller 1302, and the memory 1304 may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may receive a message comprising a pattern of SSBs spanning a time duration, wherein the SSBs comprise one or more synchronization signals and one or more broadcast messages, determine, based on the pattern of SSBs, a first subset of SSB indices associated with a first time period of the time duration and a second subset of SSB indices associated with a second time period of the time duration, wherein the first and second subsets of SSB indices have at least one index that is common and at least one index that is different, and wherein the first and second time periods do not overlap, and receive an SSB in accordance with an associated SSB index based on the pattern of SSBs, the first and second subsets of SSB indices, and the time period corresponding to the SSB.

In one embodiment, the first time period comprises a first set of slots and the second time period comprises a second set of slots, and wherein, for at least one SSB index, a slot index within the first time period is different than a corresponding slot index with the second time period. In one embodiment, the first and second time periods comprise the same number of slots.

In one embodiment, the first time period comprises a first set of slots and the second time period comprises a second set of slots, and wherein, a first SSB index is associated with a first slot index within the first time period and a second SSB index is associated with a second slot index within the second time period, and wherein the first slot index is different than the second slot index. In one embodiment, the first and second time periods comprise the same number of slots.

In one embodiment, the time duration is a multiple of a duration in which a MIB remains the same. In one embodiment, the first and second time periods are associated with a SSB burst duration or a MIB duration.

In one embodiment, the first and second time periods each have a duration of a half frame. In one embodiment, the pattern of SSBs in the time duration comprises SSB indices associated with the first time period and the second time period.

In one embodiment, the message comprises an interleaving parameter for SSB indices. In one embodiment, the processor 1300 is configured to cause the UE to further determine the SSB indices associated with the first and second time periods based on the interleaving parameter.

In one embodiment, the first time period, the second time period, or a combination thereof comprises up to a predetermined number of SSB indices. In one embodiment, the first time period corresponds to an odd frame and the second time period corresponds to an even frame.

In one embodiment, the processor 1300 is configured to detect a synchronization signal, determine, based on the detected synchronization signal presence of an SSB wherein the SSB is at least comprised of a set of PBCH symbols, detect DMRS of a first number of PBCH symbols of the SSB, determine based on the detected DMRS, a second number of PBCH symbols, and decode PBCH of the SSB based on the second number of PBCH symbols.

In one embodiment, the second number of PBCH symbols is not smaller than the first number of PBCH symbols. In one embodiment, the at least one of the additional PBCH symbols of the second number of PBCH symbols does not include any DMRS REs or has smaller number of DMRS REs compared to the PBCH symbols of the first number of PBCH symbols.

In one embodiment, the additional PBCH symbols of the second number of PBCH symbols occur after the first number of PBCH symbols in the SSB. In one embodiment, the processor 1300 is configured to receive a higher layer message indicating whether the location of SSBs of the same index change from one time period to another time period according to a predetermined pattern. In one embodiment, the location of SSBs of the same index can be either in a first portion of a slot or a second portion of the slot.

In one embodiment, the processor 1300 may be configured to determine DMRS for symbols of a first SSB and symbols of a second SSB, wherein the first SSB has more DMRS subcarriers than the second SSB.

In one embodiment, the first SSB has more symbols than the second SSB. In one embodiment, a first PBCH symbol of the first SSB has more DMRS subcarriers than a second PBCH symbol of the second SSB, and the difference between the number of subcarriers of the first PBCH symbol and the second PBCH symbols is smaller than a threshold. In one embodiment, the DMRS of a subset of symbols associated with the first SSB indicates at least one of the number of PBCH symbols or the number of SSB symbols of the first SSB.

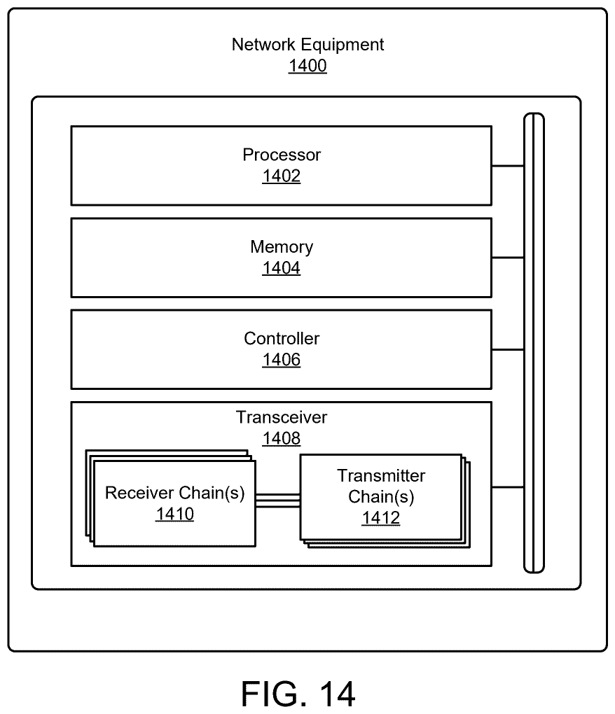

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas for receiving the signal over the air or wireless medium. The receiver chain 1410 may include at least one amplifier (e.g., a low-noise amplifier (LNA)) configured to amplify the received signal. The receiver chain 1410 may include at least one demodulator configured to demodulate the received signal and obtain the transmitted data by reversing the modulation technique applied during transmission of the signal. The receiver chain 1410 may include at least one decoder for decoding and processing the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

In one embodiment, the NE 1200 may be configured to determine a pattern for occurrence of SSBs, wherein the SSBs occur in at least two SSB bursts and each of the two SSB bursts include SSBs with at least one common SSB index and one different SSB index in the at least two SSB bursts, and the at least two SSB bursts are non-overlapping in time and transmit a signal indicating the pattern for occurrence of SSBs.

In one embodiment, the NE 1200 may be configured to determine DMRS for symbols of a first SSB and symbols of a second SSB, wherein the first SSB has more DMRS subcarriers than the second SSB.

In one embodiment, the first SSB has more symbols than the second SSB. In one embodiment, a first PBCH symbol of the first SSB has more DMRS subcarriers than a second PBCH symbol of the second SSB, and the difference between the number of subcarriers of the first PBCH symbol and the second PBCH symbols is smaller than a threshold. In one embodiment, the DMRS of a subset of symbols associated with the first SSB indicates at least one of the number of PBCH symbols or the number of SSB symbols of the first SSB.

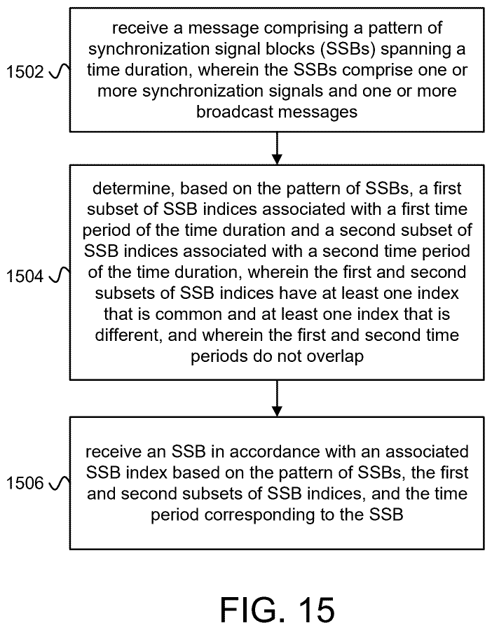

FIG. 15 illustrates a flowchart of a method in accordance with aspects of the present disclosure. The operations of the method may be implemented by a UE as described herein. In some implementations, the UE may execute a set of instructions to control the function elements of the UE to perform the described functions.

At 1502, the method may receive a message comprising a pattern of SSBs spanning a time duration, wherein the SSBs comprise one or more synchronization signals and one or more broadcast messages. The operations of 1502 may be performed in accordance with examples as described herein. In some implementations, aspects of the operations of 1502 may be performed by a UE as described with reference to FIG. 12.

At 1504, the method may determine, based on the pattern of SSBs, a first subset of SSB indices associated with a first time period of the time duration and a second subset of SSB indices associated with a second time period of the time duration, wherein the first and second subsets of SSB indices have at least one index that is common and at least one index that is different, and wherein the first and second time periods do not overlap. The operations of 1504 may be performed in accordance with examples as described herein. In some implementations, aspects of the operations of 1504 may be performed by a UE as described with reference to FIG. 12.

At 1506, the method may receive an SSB in accordance with an associated SSB index based on the pattern of SSBs, the first and second subsets of SSB indices, and the time period corresponding to the SSB. The operations of 1508 may be performed in accordance with examples as described herein. In some implementations, aspects of the operations of 1508 may be performed by a UE as described with reference to FIG. 12.

It should be noted that the method described herein describes A possible implementation, and that the operations and the steps may be rearranged or otherwise modified and that other implementations are possible.

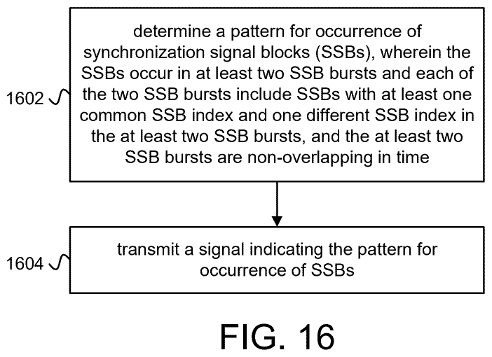

FIG. 16 illustrates a flowchart of a method in accordance with aspects of the present disclosure. The operations of the method may be implemented by a NE as described herein. In some implementations, the NE may execute a set of instructions to control the function elements of the NE to perform the described functions.

At 1602, the method may determine a pattern for occurrence of SSBs, wherein the SSBs occur in at least two SSB bursts and each of the two SSB bursts include SSBs with at least one common SSB index and one different SSB index in the at least two SSB bursts, and the at least two SSB bursts are non-overlapping in time. The operations of 1602 may be performed in accordance with examples as described herein. In some implementations, aspects of the operations of 1602 may be performed by a NE as described with reference to FIG. 14.

At 1604, the method may transmit a signal indicating the pattern for occurrence of SSBs. The operations of 1604 may be performed in accordance with examples as described herein. In some implementations, aspects of the operations of 1604 may be performed by a NE as described with reference to FIG. 14.

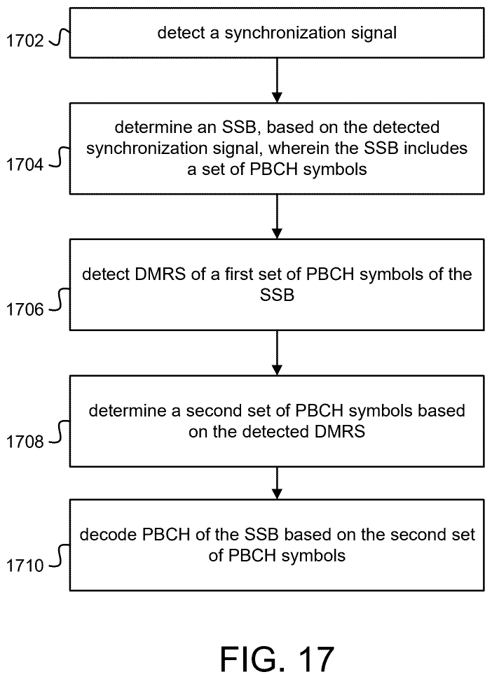

FIG. 17 illustrates a flowchart of a method in accordance with aspects of the present disclosure. The operations of the method may be implemented by a UE as described herein. In some implementations, the UE may execute a set of instructions to control the function elements of the UE to perform the described functions.

At 1702, the method may detect a synchronization signal. The operations of 1702 may be performed in accordance with examples as described herein. In some implementations, aspects of the operations of 1702 may be performed by a UE as described with reference to FIG. 12.

At 1704, the method may determine an SSB, based on the detected synchronization signal, wherein the SSB includes a set of PBCH symbols. The operations of 1704 may be performed in accordance with examples as described herein. In some implementations, aspects of the operations of 1704 may be performed by a UE as described with reference to FIG. 12.

At 1706, the method may detect DMRS of a first set of PBCH symbols of the SSB. The operations of 1706 may be performed in accordance with examples as described herein. In some implementations, aspects of the operations of 1706 may be performed by a UE as described with reference to FIG. 12.

At 1708, the method may determine a second set of PBCH symbols based on the detected DMRS. The operations of 1708 may be performed in accordance with examples as described herein. In some implementations, aspects of the operations of 1708 may be performed by a UE as described with reference to FIG. 12.

At 1710, the method may decode PBCH of the SSB based on the second set of PBCH symbols. The operations of 1710 may be performed in accordance with examples as described herein. In some implementations, aspects of the operations of 1710 may be performed by a UE as described with reference to FIG. 12.

It should be noted that the method described herein describes A possible implementation, and that the operations and the steps may be rearranged or otherwise modified and that other implementations are possible.

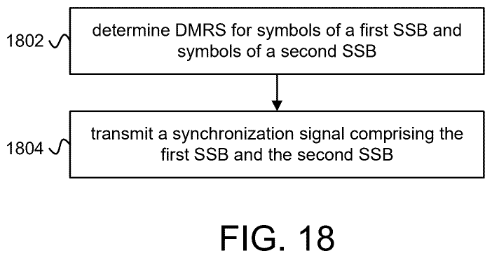

FIG. 18 illustrates a flowchart of a method in accordance with aspects of the present disclosure. The operations of the method may be implemented by a NE as described herein. In some implementations, the NE may execute a set of instructions to control the function elements of the NE to perform the described functions.

At 1802, the method may determine DMRS for symbols of a first SSB and symbols of a second SSB. The operations of 1802 may be performed in accordance with examples as described herein. In some implementations, aspects of the operations of 1802 may be performed by a NE as described with reference to FIG. 14.

At 1804, the method may transmit a synchronization signal comprising the first SSB and the second SSB. The operations of 1804 may be performed in accordance with examples as described herein. In some implementations, aspects of the operations of 1804 may be performed by a NE as described with reference to FIG. 14.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a message comprising a pattern of synchronization signal blocks (SSBs) spanning a time duration, wherein the SSBs comprise one or more synchronization signals and one or more broadcast messages;
determine, based on the pattern of SSBs, a first subset of SSB indices associated with a first time period of the time duration and a second subset of SSB indices associated with a second time period of the time duration, wherein the first and second subsets of SSB indices have at least one index that is common and at least one index that is different, and wherein the first and second time periods do not overlap; and
receive an SSB in accordance with an associated SSB index based on the pattern of SSBs, the first and second subsets of SSB indices, and the time period corresponding to the SSB.

2. The UE of claim 1, wherein the first time period comprises a first set of slots and the second time period comprises a second set of slots, and wherein, for at least one SSB index, a slot index within the first time period is different than a corresponding slot index with the second time period.

3. The UE of claim 2, wherein the first and second time periods comprise the same number of slots.

4. The UE of claim 1, wherein the first time period comprises a first set of slots and the second time period comprises a second set of slots, and wherein, a first SSB index is associated with a first slot index within the first time period and a second SSB index is associated with a second slot index within the second time period, and wherein the first slot index is different than the second slot index.

5. The UE of claim 4, wherein the first and second time periods comprise the same number of slots.

6. The UE of claim 1, wherein the time duration is a multiple of a duration in which a master information block (MIB) remains the same.

7. The UE of claim 1, wherein the first and second time periods are associated with a SSB burst duration or a master information block (MIB) duration.

8. The UE of claim 1, wherein the first and second time periods each have a duration of a half frame.

9. The UE of claim 1, wherein the pattern of SSBs in the time duration comprises SSB indices associated with the first time period and the second time period.

10. The UE of claim 1, wherein the message comprises an interleaving parameter for SSB indices.

11. The UE of claim 10, wherein the at least one processor is configured to cause the UE to further determine the SSB indices associated with the first and second time periods based on the interleaving parameter.

12. The UE of claim 1, wherein the first time period, the second time period, or a combination thereof comprises up to a predetermined number of SSB indices.

13. The UE of claim 1, wherein the first time period corresponds to an odd frame and the second time period corresponds to an even frame.

14. A processor for wireless communication, comprising:
at least one controller coupled with at least one memory and configured to cause the processor to:
receive a message comprising a pattern of synchronization signal blocks (SSBs) spanning a time duration, wherein the SSBs comprise one or more synchronization signals and one or more broadcast messages;
determine, based on the pattern of SSBs, a first subset of SSB indices associated with a first time period of the time duration and a second subset of SSB indices associated with a second time period of the time duration, wherein the first and second subsets of SSB indices have at least one index that is common and at least one index that is different, and wherein the first and second time periods do not overlap; and
receive an SSB in accordance with an associated SSB index based on the pattern of SSBs, the first and second subsets of SSB indices, and the time period corresponding to the SSB.

15. The processor of claim 14, wherein the first time period comprises a first set of slots and the second time period comprises a second set of slots, and wherein, for at least one SSB index, a slot index within the first time period is different than a corresponding slot index with the second time period.

16. The processor of claim 15, wherein the first and second time periods comprise the same number of slots.

17. The processor of claim 14, wherein the first time period comprises a first set of slots and the second time period comprises a second set of slots, and wherein, a first SSB index is associated with a first slot index within the first time period and a second SSB index is associated with a second slot index within the second time period, and wherein the first slot index is different than the second slot index.

18. The processor of claim 17, wherein the first and second time periods comprise the same number of slots.

19. A method of a user equipment (UE), comprising:
receiving a message comprising a pattern of synchronization signal blocks (SSBs) spanning a time duration, wherein the SSBs comprise one or more synchronization signals and one or more broadcast messages;
determining, based on the pattern of SSBs, a first subset of SSB indices associated with a first time period of the time duration and a second subset of SSB indices associated with a second time period of the time duration, wherein the first and second subsets of SSB indices have at least one index that is common and at least one index that is different, and wherein the first and second time periods do not overlap; and
receiving an SSB in accordance with an associated SSB index based on the pattern of SSBs, the first and second subsets of SSB indices, and the time period corresponding to the SSB.

20. A network equipment (NE) for wireless communication, comprising:
at least one memory; and
at least one processor coupled with the at least one memory and configured to cause the NE to:
determine a pattern for occurrence of synchronization signal blocks (SSBs), wherein the SSBs occur in at least two SSB bursts and each of the two SSB bursts include SSBs with at least one common SSB index and one different SSB index in the at least two SSB bursts, and the at least two SSB bursts are non-overlapping in time; and
transmit a signal indicating the pattern for occurrence of SSBs.
